(19) United States
(12) Patent Application Publication
(10) Pub. No.: US 2007/0072085 A1
(43) Pub. Date: Mar. 29, 2007

(54) Overcharge protection for electrochemical cells

(76) Inventors: Zonghai Chen, Downers Grove, IL (US); Khalil Amine, Downers Grove, IL (US)

Correspondence Address: AIR PRODUCTS AND CHEMICALS, INC.;PATENT DEPARTMENT, 7201 HAMILTON BOULEVARD, ALLENTOWN, PA, 181951501, US

(21) Appl. No.: 11/520,564

(22) Filed: Sep. 14, 2006

Related U.S. Application Data
(60) Provisional application No. 60/720,610, filed on Sep. 26, 2005.

(51) Int. Cl. H01M 10/40

(52) U.S. Cl. 429/324; 429/199; 429/326

(57) ABSTRACT

The invention relates to an improvement in a cell which is normally susceptible to damage from overcharging comprised of a negative electrode, a positive electrode, and an electrolyte comprised of an overcharge protection salt carried in a carrier or solvent. Representative overcharge protection salts are embraced by the formula:
MₐQ where M is an electrochemically stable cation selected from the group consisting of alkali metal, alkaline earth metal, tetraalkylammonium, or imidazolium groups, and Q is a borate or heteroborate cluster and a is the integer 1 or 2.

### CROSS-REFERENCE TO RELATED APPLICATIONS

This application claims the benefit of Provisional Application No. 60/720,610, filed on Sep. 26, 2005. The disclosure of that Application is hereby incorporated by reference.

The subject matter disclosed herein is related to U.S. patent application Ser. No. 11/097,810, filed Apr. 1, 2005, and entitled “Overcharge Protection For Electrochemical Cells”; the disclosure of which is hereby incorporated by reference.

### STATEMENT REGARDING FEDERALLY SPONSORED RESEARCH OR DEVELOPMENT

The United States Government has rights in this invention pursuant to ANL Agreement No. 85N14.

### BACKGROUND OF THE INVENTION

Primary and secondary batteries comprise one or more electrochemical cells. Many batteries comprise lithium cells, because of lithium's large reduction potential, low molecular weight of elemental lithium, and high power density. For secondary cells, the small size and high mobility of lithium cations allow for the possibility of rapid recharging. These advantages make lithium secondary batteries ideal for portable electronic devices, e.g., cell phones and laptop computers. Recently, larger size lithium batteries are being developed which have application for use in the hybrid electric vehicle market.

In a lithium secondary cell one of most important concerns is safety and, in particular, the safety problem posed by an overcharge situation, i.e., the application of an overvoltage to a fully charged cell. One danger of overcharging lithium cells employing metal oxide cathodes is that oxygen evolution can occur and create explosive mixtures within the cell. Another danger is that the cell can overheat and cause burns.

In the case of a lithium-based secondary cell, which is of the non-aqueous type, two methods have been developed for dealing with overcharge; one method utilizes a chemical reaction and the other method an electronic circuit. The chemical method has typically involved the addition of a redox shuttle additive also referred to as a reversible oxidation/reduction agent, which is reversibly oxidized just above the fully charged cell voltage. Then, the additive migrates across the electrolyte solution in its oxidized state to the anode where it is reduced back to its original state. Electronic circuits typically disable, sometimes permanently, the battery when activated.

The following patents are representative of lithium secondary batteries and electrochemical cells:

U.S. Pat. No. 5,763,119 discloses non-aqueous lithium secondary cells having overcharge protection. In the background of the patent a technique for preventing the overcharge of the cell using a chemical reaction is suggested wherein it is recommended that a reversible redox agent be added to the electrolyte solution. Fe, Ru and Ce complexes are described as having high oxidation-reduction potential and high electrochemical stability and, therefore, use as reversible oxidation/reduction agents for 4 volt-class lithium-ion secondary cells. The solution for preventing overcharge damage in '119 involved the addition of a substituted benzene, e.g., a dimethoxy fluoro or bromo benzene as a redox shuttle in a cell comprised of a metal lithium anode, a lithium cobalt oxide cathode, LiPF₆ electrolyte salt and a mixture of propylene carbonate and dimethyl carbonate.

U.S. Pat. No. 4,201,839 discloses an electrochemical cell based upon alkali metal-containing anodes, solid cathodes, and electrolytes where the electrolytes are closoborane compounds carried in aprotic solvents. Closoboranes employed are of the formula Z₂BₙXₙ and ZCBₘXₘ wherein Z is an alkali metal, C is carbon, R is a radical selected from the group consisting of organic hydrogen and halogen atoms, B is boron, X is one or more substituents from the group consisting of hydrogen and the halogens, m is an integer from 5 to 11, and n is an integer from 6 to 12. Specifically disclosed examples of closoborane electrolytes employed in the electrochemical cells include lithium octabromooctaborate, lithium decachlorodecaborate, lithium dodecachlorododecaborate, and lithium iododecaborate.

U.S. Pat. No. 6,346,351 discloses electrolyte systems for a rechargeable cell of high compatibility towards positive electrode structures based upon a salt and solvent mixture. Lithium tetrafluoroborate and lithium hexafluorophosphate are examples of salts. Examples of solvents include diethyl carbonate, dimethoxyethane, methylformate, and so forth. In the background are disclosed known electrolytes for lithium cells, which include lithium perchlorate, lithium hexafluoroarsenate, lithium trifluoromethylsulfonate, lithium tetrafluoroborate, lithium bromide, and lithium hexafluoroantimonate electrolytes incorporated in solvents.

Journal of the Electrochemical Society, 151 (9) A1429-A1435 (2004) and references therein disclose boronate, borate and borane-based Lewis acids as additives capable of solubilizing LiF and other Li salts which typically have poor solubility in non-aqueous solvent systems, thus rendering these salts lithium ion electrolytes in lithium ion cells.

The previously identified patents, patent applications and publications are hereby incorporated by reference.

### BRIEF SUMMARY OF THE INVENTION

This invention solves problems associated with conventional electrolytes by providing improved overcharge protection to an electrochemical cell comprising a negative electrode, a positive electrode, and an electrolyte. While any suitable electrolyte can be employed an example of a suitable electrolyte comprises that disclosed in Published Patent Application Nos US20050053841A1 and US20050064288 A1; hereby incorporated by reference. The present invention is useful for primary and secondary cells, especially those that may be susceptible to damage from overcharging. By “overcharge” or “overcharging” it is meant charging a cell to a potential above the normal fully charged potential of the cell, or charging a cell above 100% state of charge.

One aspect of the instant invention relates to extending the overcharge capacity of cells such as those described in patent application Ser. No. 11/097,810 by using at least one additive. Without wishing to be bound by any theory or explanation it is believed that such additives minimize the effects of irreversible reactions that may occur in certain electrolyte/cells. It is also believed that effective additives are those which can minimize the amount of fluoride formed in the cell on overcharge, and those which are capable of dissolving any fluoride or other resistive salts formed at the electrode surfaces.

### BRIEF DESCRIPTION OF SEVERAL VIEWS OF THE DRAWINGS

FIG. 1 is a graph of capacity retention v. cycle number for Examples 1-5.

FIG. 2 is a graph of voltage v. time for Example 6.

FIG. 3 is a graph of voltage v. time for Example 7.

FIG. 4 is a graph of voltage v. time for Example 8.

FIG. 5 is a graph of capacity v. cycle number for Examples 2, 6, 7 and 8.

FIG. 6 is a graph of capacity v. cycle for Example 8.

### DETAILED DESCRIPTION OF THE INVENTION

Patent Application Publication No. US20050064288 A1 discloses the ranges of borate cluster salts useful for electrochemical cells, the useful salts for lithium ion cells and the use of other electrolyte salts with the borate cluster salts to provide stable Solid Electrolyte Interface (SEI) layers in lithium ion cells. U.S. patent application Ser. No. 11/097,810 discloses classes of borate cluster salts that are useful for providing overcharge protection to electrochemical cells such as lithium ion cells.

While certain salts provide overcharge protection for extended periods of time, in some cases the redox shuttle chemistry is not completely reversible (e.g., that is the borate cluster salts do undergo slow decomposition during the overcharging process). The products of this decomposition reaction can lead to electrically and ionically resistive layers on the electrodes which in turn may lead to a significant decrease in discharge capacity of the cells on long term overcharging. In some cases, an extended overcharge could occur in one or more cells in a series of cells or pack during trickle charging (e.g., trickle charging is defined as the low rate charging of a cell pack to main full pack potential), or during multiple charges of the pack if the cell (or cells) undergoing overcharge has lower capacity than the other cells in the pack.

The instant invention provides an electrolyte which allows the borate cluster salts to provide prolonged overcharge protection without substantially contributing to capacity fade of cells (e.g, by capacity fade it is meant loss of electrochemical energy storage capability after overcharging, or on successive charging and discharging of the cell). The electrolyte solution of this invention can be non-aqueous and comprise the borate cluster salts and a lithium bis-oxalato borate (e.g, as an SEI layer forming additive). The amount of lithium bis-oxalato borate will normally range from about 0.1 to about 5 wt. % of the electrolyte.

The inventive electrolyte can also incorporate a molecular (non-salt) fluorinated tri-substituted borane acid such as tris-(perfluorophenyl) borane (e.g, as an anion receptor which appears to hinder the buildup of resistive films brought about by borate decomposition that can occur during overcharge). Other suitable tri-substituted acids can be selected from the list of borates-boron containing acids in which B is bonded to 3 oxygens, boronates-boron containing acids in which the boron is bound to a mixture of 3 carbons and oxygens, and boranes-boron containing acids in which the boron is bound to 3 carbons. Other soluble, non-HF generating Lewis acids may be effective in extending the life of overcharge protection provided by the borate cluster salt. If desired, the acid can be used in an electrolyte that also contains lithium bis-oxalato borate. The amount of acid normally ranges from about 0.1 to about 5 wt. % of the electrolyte. The instant invention can increase the length of effective overcharge and hence overcharge capacity can be extended greater than 4 times.

The inventive electrolyte can be produced by combining the electrolyte ingredients in conventional equipment and using conventional methods. In a typical embodiment the electrolye formula will contain 75-99 wt. % solvent, 1-20 wt. % salt, 0.1 to 5 wt. % acid and 0.1 to 5 wt. % LiBOB.

The following Examples are provided to illustrate certain aspects of the invention a and shall not limit the scope of any claims appended hereto.

### EXAMPLE 1

A coin type cell battery (diameter 20 mm, thickness 3.2 mm) comprised of a positive electrode, negative electrode, separator and electrolyte was prepared at room temperature. The positive electrode consists of LiMn₂O₄ (positive electrode active material) 84% by weight, carbon black (conducting agent) 4% by weight, SFG-6 graphite (conducting agent) 4% by weight, polyvinylidene fluoride (binder) 8% by weight on an aluminum foil current collector. The negative electrode consists of MCMB (anode active material) 92% by weight, polyvinylidene fluoride (binder) 8% by weight on a copper foil current collector. The separator, Celgard™ 3501, (available from Celgard Inc.) comprises the microporous polypropylene film.

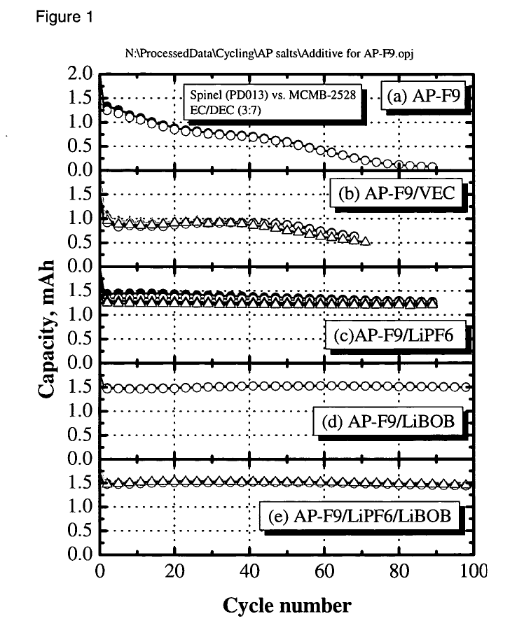

The electrolyte was a 0.4 M solution of Li₂B₁₂F₉H₃ in 3:7 by weight EC:DEC. The cell was charged and discharged multiple times at a C/3-rate constant current between 3.0 and 4.2 V. The capacity retention vs cycle number is shown in FIG. 1a. Rapid capacity fade was observed with complete capacity fade occuring over 80 cycles.

### EXAMPLE 2

A cell was fabricated and cycled as in Example 1, with the exception that 1% vinylethylene carbonate was added to the electrolyte solution of 0.4 M Li₂B₁₂F₉H₃ in 3:7 by weight EC:DEC to help improve formation of a solid electrolyte interface at the negative electrode. As can be seen in FIG. 1b, capacity retention was improved over example 1; however, greater than 50% capacity loss was observed over 80 cycles and an initial irreversible capacity loss was also observed.

### EXAMPLE 3

A cell was fabricated and cycled as in Example 1, with the exception that the electrolyte solution was 0.36 M Li₂B₁₂F₉H₃ and 0.08 M LiPF₆ in 3:7 by weight EC:DEC. The LiPF₆ was added to help improve formation of a solid electrolyte interface at the negative electrode. As can be seen in FIG. 1c, capacity retention was improved over Examples 1 and 2. Capacity fade was observed on cycling.

### EXAMPLE 4

A cell was fabricated and cycled as in Example 1, with the exception that the electrolyte solution was 0.36 M Li₂B₁₂F₉H₃ and 0.08 M lithium bis-oxalatoborate (LiBOB) in 3:7 by weight EC:DEC. The LiBOB was added (e.g., to improve formation of a solid electrolyte interface at the negative electrode without adding a source of HF as with LiPF₆ addition in Example 3). As can be seen in FIG. 1d, no capacity loss was observed over 100 charge/discharge cycles.

### EXAMPLE 5

A cell was fabricated and cycled as in Example 1, with the exception that the electrolyte solution was 0.36 M Li₂B₁₂F₉H₃, 0.04 LiBOB and 0.04 M LiPF₆ in 3:7 by weight EC:DEC. As can be seen in FIG. 1e, very slow capacity fade is observed on cycling. This result and those of Examples 3 and 4 indicate that both LiPF₆ and LiBOB are capable of forming stable SEI layers on MCMB with electrolytes containing borate cluster salt, but that LiBOB alone as an additive was better than LiPF₆ alone or in combination with LiPF₆. Without wishing to be bound by any theory or explanation this result may be due to the sensitivity of the LiMn₂O₄ positive electrode in the presence of traces of HF contained in LiPF₆.

### EXAMPLE 6

### Overcharge Protection with Li₂B₁₂F₉H₃-Based Electrolyte

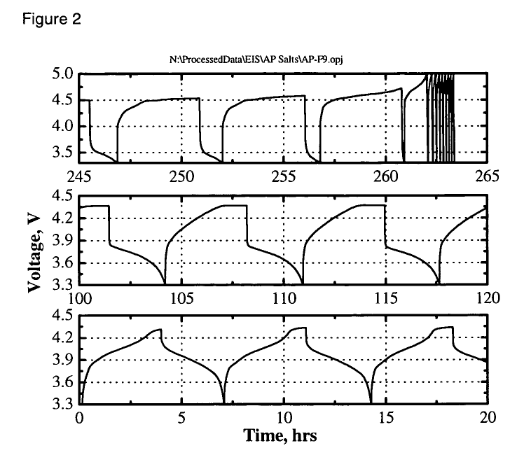

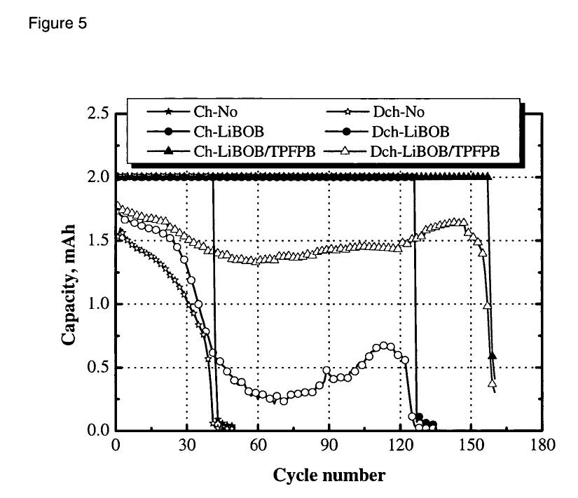

A cell was fabricated as in Example 1 with an electrolyte comprising 0.4 M Li₂B₁₂F₉H₃ in 3:7 by weight EC:DEC. In each charge/discharge cycle, the cell was charged at a C/3 rate for 4 hrs followed by a constant current discharge at C/3 rate to 3.0 V. Such a charging protocol effectively overcharges the cell at to at least 33% above its full charge capacity. The cycle data presented in FIG. 2 show that the cell potential is limited to ˜4.5 V on overcharge by the use of the Li₂B₁₂F₉H₃ electrolyte and that this overcharge protection lasts for ˜40 of the mentioned overcharge/discharge cycles. This electrolyte provides a total of ˜260 hrs overcharge protection at this overcharging rate, after which time the cell potential is no longer limited on overcharge. FIG. 5 shows the charging capacity and discharge capacity retention on overcharging indicates that this cell rapidly loses 4.2 to 3V discharge capacity and by the time the overcharge protection fails, no capacity remains in the cell.

### EXAMPLE 7

### Overcharge Protection with Li₂B₁₂F₉H₃-Based Electrolyte+LIBOB Additive

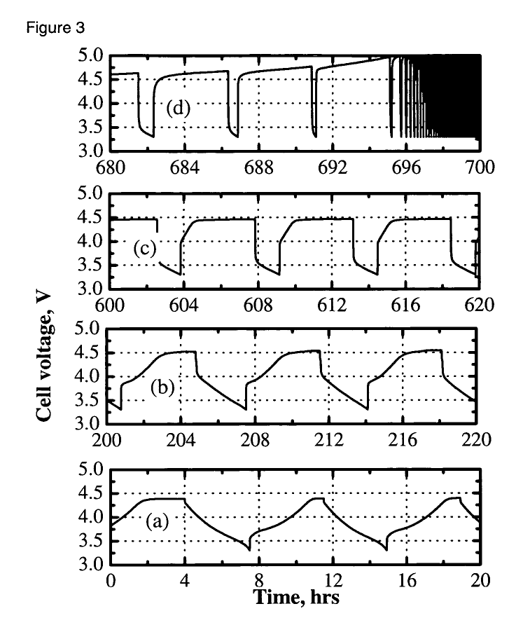

A cell was fabricated as in Example 1 with an electrolyte comprising 0.36 M Li₂B₁₂F₉H₃ and 0.08M lithium bis(oxalato)borate (LiBOB) in 3:7 by weight EC:DEC. In each charge/discharge cycle, the cell was charged at a C/3 rate for 4 hrs followed by a constant current discharge at C/3 rate to 3.0 V. Such a charging protocol effectively overcharges the cell at to at least 33% above its full charge capacity. The cycle data presented in FIG. 3 show that the cell potential is limited to ˜4.5 V on overcharge by the use of the Li₂B₁₂F₉H₃ electrolyte and that this overcharge protection lasts for ˜100 of the mentioned overcharge/discharge cycles. This electrolye formulation provides a total of ˜680 hrs overcharge protection at this overcharging rate, after which time the cell potential is no longer limited on overcharge. FIG. 5 showing the charging capacity and discharge capacity retention on overcharging indicates that this cell loses 4.2 to 3V discharge capacity at a slower rate than the cell of example 6 and stabilizes at ˜30-40% of the full charge capacity between overcharge cycles 40 and 120. At the time the overcharge protection fails, no 4.2V to 3V discharge capacity remains in the cell.

### EXAMPLE 8

### Overcharge Protection with Li₂B₁₂F₉H₃-Based Electrolyte+LIBOB Additive+tris(pentafluorophenyl)borane Additive

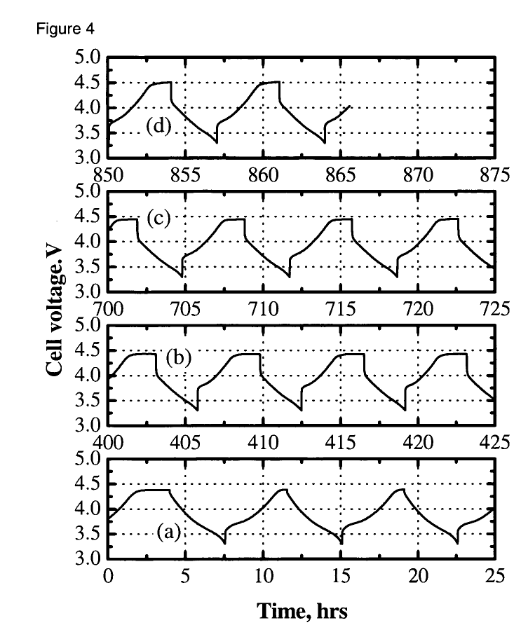

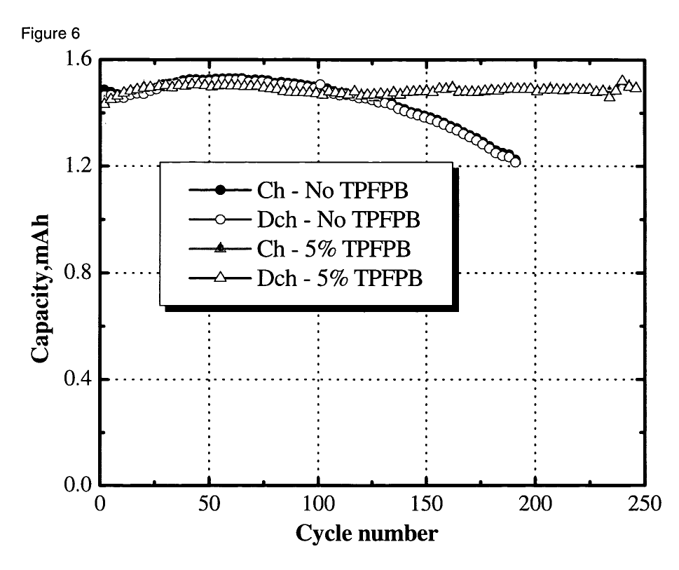

A cell was fabricated as in Example 1 with an electrolyte comprising 0.36 M Li₂B₁₂F₉H₃ and 0.08M lithium bis(oxalato)borate (LiBOB) and 5 wt. % tris(pentafluorophenyl)borane in 3:7 by weight EC:DEC. In each charge/discharge cycle, the cell was charged at a C/3 rate for 4 hrs followed by a constant current discharge at C/3 rate to 3.0 V. Such a charging protocol effectively overcharges the cell at to at least 33% above its full charge capacity. The cycle data presented in FIG. 4 show that the cell potential is limited to ˜4.5 V on overcharge by the use of the Li₂B₁₂F₉H₃ electrolyte and that this overcharge protection is still effective after ˜160 of the mentioned overcharge/discharge cycles. This electrolyte formulation was still providing overcharge protection after 865 hrs at this overcharging rate. FIG. 5 shows that 4.2 to 3 V discharge capacity retention is quite good even over the 160 overcharge cycles of this test. FIG. 6 shows the affect of using 5% TPFPB.

1. An electrochemical cell comprising a negative electrode, a positive electrode, and an electrolyte, said electrolyte comprising at least one salt that provides overcharge protection, at least one carrier, and at least one additive, wherein the additive comprises at least one Lewis acid, wherein said salt that provides overcharge protection comprises a salt of the formula:
MₐQ
where M is an electrochemically stable cation, Q is a borate cluster anion or heteroborate cluster anion, and a is 1 or 2.

2. The cell of claim 1 wherein said electrolyte further comprises at least one nonreversibly oxidizable salt.

3. The cell of claim 1 wherein M comprises at least one member selected from the group consisting of alkali metal, alkaline earth metal, tetraalkylammonium, and imidazolium.

4. The cell of claim 1 wherein M comprises lithium.

5. The cell of claim 1 wherein Q comprises at least one member selected from the group consisting of: i) a closo-borate anion of the formula (B₈₋₁₂Z₈₋₁₂)²⁻, where Z is F, H, Cl, Br, or (OR), where R is H, alkyl or fluoroalkyl, ii) a closo-ammonioborate anion compositions of formula: ((R′R″R′″)NB₈₋₁₂Z₇₋₁₁)¹⁻; where N is bonded to B and each of R′, R″, R′″ is independently selected from the group consisting of hydrogen, alkyl, cycloalkyl, aryl and/or a polymer, Z is F, H, Cl, Br, or (OR), where R is H, alkyl or fluoroalkyl, and iii) a closo-monocarborate anion compositions of formula (R″″CB₇₋₁₂Z₇₋₁₁)¹⁻, where R″″ is bonded to C and selected from the group consisting of hydrogen, alkyl, cycloalkyl, aryl, and/or a polymer; Z is F, H, Cl, Br, or (OR), where R is H, alkyl or fluoroalkyl.

6. The cell of claim 5 wherein Q comprises closo-borate anion of the formula (B₈₋₁₂Z₈₋₁₂)²⁻, where Z is F, H, Cl, Br, or (OR), where R is H, C₁₋₈ alkyl or fluoroalkyl.

7. The cell of claim 6 wherein the subscript a is 2.

8. The cell of claim 7 wherein the salt that provides overcharge protection comprises at least one member selected from the group consisting of Li₂B₁₀H₀₋₇Z₃₋₁₀ where Z is Cl, OR, Li₂B₁₀Cl₁₀, Li₂B₁₀H₁₋₅Cl₅₋₉, Li₂B₁₀Cl₅₋₉(OR)₁₋₅, Li₂B₁₀H₂Cl₈; Li₂B₁₀H₀₋₇(OCH₃)₃, Li₂B₁₀Cl₈(OH)₂, Li₂B₁₀Br₁₀, Li₂B₈Br₈, Li₂B₁₂Cl₁₂, and Li₂B₁₂I₁₂.

9. The cell of claim 1 wherein the acid will not substantially hydrolyze to generate HF.

10. The cell of claim 9 wherein the acid comprises a substituted boron containing Lewis acid.

11. The cell of claim 10 wherein said boron containing Lewis acid comprises at least one member selected from the group consisting of boranes, boronates and borates.

12. The cell of claim 11 wherein said boron containing Lewis acid comprises tris(pentafluorophenyl)borane.

13. The cell of claim 2 wherein the nonreversible oxidizable salt comprises lithium.

14. The cell of claim 8, wherein said nonreversible oxidizable salt comprises at least one member selected from the group consisting of lithium perchlorate, lithium hexafluorophosphate, lithium hexafluoroarsenate, lithium hexafluoroborate, lithium trifluoromethylsulfonate, lithium tetrafluoroborate, lithium tetrakis(pentafluorophenyl)borate lithium bromide, and lithium hexafluoroantimonate, LiB(C₆H₅)₄, LiN(SO₂CF₃)₂, LiN(SO₂CF₂CF₃) and lithium bis(chelato)borates and mixtures thereof.

15. The cell of claim 1 wherein the at least one carrier comprises an aprotic organic comprising at least one member selected from the group consisting of dimethyl carbonate, ethyl methyl carbonate, diethyl carbonate, methyl propyl carbonate, ethyl propyl carbonate, dipropyl carbonate, bis(trifluoroethyl)carbonate, bis(pentafluoropropyl)carbonate, trifluoroethyl methyl carbonate, pentafluoroethyl methyl carbonate, heptafluoropropyl methyl carbonate, perfluorobutyl methyl carbonate, trifluoroethyl ethyl carbonate, pentafluoroethyl ethyl carbonate, heptafluoropropyl ethyl carbonate, perfluorobutyl ethyl carbonate, etc., fluorinated oligomers, methyl propionate, butyl propionate, ethyl propionate, sulfolane, 1,2-dimethoxyethane, 1,2-diethoxyethane, tetrahydrofuran, 1,3-dioxolane, 4-methyl-1,3-dioxolane dimethoxyethane, triglyme, dimethylvinylene carbonate, vinylene carbonate, chloroethylene carbonate, tetraethyleneglycol, dimethyl ether, polyethylene glycols, sulfones, and gamma-butyrolactone.

16. The cell of claim 3 wherein the salt that provides overcharge protection comprises at least one lithium fluoroborate selected from the group consisting of those compounds represented by the formulas:
Li₂B₁₀FₓZ₁₀₋ₓ
and
Li₂B₁₂FₓZ₁₂₋ₓ
wherein x is at least 3 for the decaborate salt and at least 5 for the dodecaborate salt, and Z represents H, Cl, Br, or OR, where R=H, C₁₋₈ alkyl or fluoroalkyl.

17. The cell of claim 12 wherein the lithium fluoroborate has a reversible oxidation potential from 0.1 to 1 volt above the voltage of the cell.

18. The cell of claim 13 wherein the lithium fluoroborate salt in added in an amount from about 3 to about 70% by weight of the total weight of said nonreversibly oxidizable salt and said salt that provides overcharge protection present in the cell.

19. The cell of claim 14 wherein the nonreversibly oxidizable salt comprises at least one member selected from the group consisting of lithium perchlorate, lithium hexafluorophosphate, lithium hexafluoroarsenate, lithium hexafluoroborate, lithium trifluoromethylsulfonate, lithium tetrafluoroborate, lithium tetrakis(pentafluorophenyl)borate lithium bromide, lithium hexafluoroantimonate, LiB(C₆H₅)₄, LiN(SO₂CF₃)₂, LiN(SO₂CF₂CF₃) and lithium bis(chelato)borates, and mixtures thereof.

20. The cell of claim 14 wherein the salt that provides overcharge protection comprises at least one member selected from the group consisting of Li₂B₁₂F₂ Li₂B₁₂FₓH₁₂₋ₓ (x=10, 11 and/or 12), Li₂B₁₂FₓCl₁₂₋ₓ (x=6, 7, 8, 9, 10, 11 and/or 12), Li₂B₁₂Fₓ(OH)₁₂₋ₓ (x=110 and/or 11), Li₂B₁₂Fₓ(OH)₂, Li₂B₁₂F₅H₇ and Li₂B₁₀Cl₁₀.

21. The cell of claim 16 wherein the carrier comprises at least one member selected from the group consisting of dimethyl carbonate, ethyl methyl carbonate, diethyl carbonate, methyl propyl carbonate, ethyl propyl carbonate, dipropyl carbonate, bis(trifluoroethyl)carbonate, bis(pentafluoropropyl)carbonate, trifluoroethyl methyl carbonate, pentafluoroethyl methyl carbonate, heptafluoropropyl methyl carbonate, perfluorobutyl methyl carbonate, trifluoroethyl ethyl carbonate, pentafluoroethyl ethyl carbonate, heptafluoropropyl ethyl carbonate, perfluorobutyl ethyl carbonate, etc., fluorinated oligomers, methyl propionate, butyl propionate, ethyl propionate, sulfolane, 1,2-dimethoxyethane, 1,2-diethoxyethane, tetrahydrofuran, 1,3-dioxolane, 4-methyl-1,3-dioxolane dimethoxyethane, triglyme, dimethylvinylene carbonate, vinylene carbonate, chloroethylene carbonate tetraethyleneglycol, dimethyl ether, polyethylene glycols, sulfones, and gamma-butyrolactone.

22. An electrochemical cell comprising a negative electrode, a positive electrode, and an electrolyte comprising at least one aprotic organic carrier, and at least one salt that provides overcharge protection.

23. The cell of claim 18, wherein said overcharge protection has a reversible oxidation potential from 0.1 to 1 volt above the voltage of the cell to act as a redox shuttle.

24. The cell of claim 18 wherein the salt that provides overcharge protection comprises a salt represented by the general formula
Li₂B₁₀X₁₀ or
Li₂B₁₂X₁₂
where X=H, F, Cl, Br, or OH.

25. The cell of claim 19 wherein the salt that provides overcharge protection comprises salt represented by the formula:
Li₂B₁₀F₈₋₁₀Z₀₋₂, or
Li₂B₁₂F₁₀₋₁₂Z₀₋₂
where Z is H or Cl.
